(19) United States
(12) Patent Application Publication
(10) Pub. No.: US 2023/0052179 A1
(43) Pub. Date: Feb. 16, 2023

(54) Liquid-Gauging Systems For Collapsible Bladders, and Related Apparatus and Methods

(71) Applicant: Liquid Measurement Systems, Inc., Georgia, VT (US)

(72) Inventors: Steven Pickering, Williston, VT (US); Derek Bibeau, Westford, VT (US); Michael Jacquinto, Burlington, VT (US)

(21) Appl. No.: 17/884,770

(22) Filed: Aug. 10, 2022

Related U.S. Application Data
(60) Provisional application No. 63/231,453, filed on Aug. 10, 2021.

(51) Int. Cl. G01F 23/263; B64D 37/06; B64C 39/02; G01F 23/16; G01F 23/20; G01F 23/80

(52) U.S. Cl. CPC G01F 23/266; B64D 37/06; B64C 39/024; G01F 23/268; G01F 23/16; G01F 23/20; G01F 23/804

(57) ABSTRACT

Liquid-gauging systems for estimating amounts of liquid within collapsible bladders. In some embodiments, a liquid-gauging system of this disclosure includes one or more liquid-gauging sensors that each output a signal relating to an amount of liquid within a corresponding collapsible bladder. In some embodiments, each liquid-gauging sensor comprises a variable capacitor having capacitor plates located so that the spacing between the capacitor plates changes with changing amounts of liquid within the collapsible bladder. In some embodiments, each liquid-gauging sensor comprises a pressure sensor for measuring forces, such as gravitational forces, that change with changing amounts of liquid within the collapsible bladder. In some embodiments, a liquid-gauging system is configured for an aircraft or other moving vehicle and includes one or more additional sensors to adjust the estimating process to account for changes in attitude of the vehicle during use. Corresponding methods, liquid-storage systems, and collapsible bladders are also disclosed.

### RELATED APPLICATION DATA

This application claims the benefit of priority of U.S. Provisional Patent Application Ser. No. 63/231,453, filed Aug. 10, 2021, and titled “LIQUID-GAUGING SYSTEM FOR A COLLAPSIBLE BLADDER AND RELATED SYSTEMS AND METHODS”, which is incorporated by reference herein in its entirety.

### FIELD OF THE INVENTION

The present invention generally relates to the field of collapsible-bladder liquid storage. In particular, the present invention is directed to liquid-gauging systems for collapsible bladders, and related apparatus and methods.

### BACKGROUND

The most common form of fuel-measurement technology for manned aircraft is capacitance-based fuel probes. Capacitance gauging is relatively unsophisticated and yet has a long track record of success due to the probe's ability to survive in hostile fuel-tank environments. The technology can achieve the accuracies required of modern aircraft, while remaining cost-effective and reliable, which means there is little incentive to develop new technology. Other methods, such as ultrasonic sensors, have been implemented with less success, as they are prone to fouling due to fuel contamination.

Capacitors are formed by placing a non-conductive medium in between two conductive plates. A capacitance-type fuel probe generally consists of two concentric tubes (serving as the conductive plates) arranged vertically in a fuel tank and bonded together at the ends to form a capacitor. As the fuel level changes within the fuel tank, the measured capacitance of the probe changes proportionally based on the difference between the dielectric properties of fuel and air. The concentric tubes are typically made of aluminum or carbon composite material, and they are rigid.

FIG. 1 illustrates an example of a conventional rigid fuel tank 100 located onboard a vehicle, such as a manned aircraft 104 (e.g., an airplane or helicopter, among others). In this example, the rigid fuel tank 100 contains three capacitance-type fuel probes 108(1) to 108(3) that each measure a local depth of fuel 112 within the rigid fuel tank. Typically, air 116 fills the space 100S within the rigid fuel tank 100 above the fuel 112.

Small Unmanned Aircraft Systems (UASs) often incorporate a collapsible fuel bladder in lieu of a rigid fuel tank. Rigid tanks retain the same shape and volume regardless of whether they are full or empty, while collapsible bladders conform to the liquid contained within them, and therefore increase and decrease in volume as liquid is added or removed. Collapsible bladders are increasing in popularity because they are fully sealed and allow the fuel to completely drain without introducing air into the fuel line, which can cause the engine to stall. Collapsible bladders also have the benefit of being easier to transport and install because they lie flat when empty.

There are no known liquid-gauging systems for collapsible-bladder fuel storage. Fuel gauging for a conventional UAS typically involves measuring remaining fuel onboard by weighing the aircraft before and after refueling operations and completing burn-rate calculations during the mission. Weighing the aircraft is time-consuming, and burn-rate calculations are inherently inaccurate due to the number of variables involved. The combination of these shortcomings renders this method suboptimal.

When empty, collapsible bladders are typically flat, with the top and bottom walls of the bladder in contact with one another. This prevents the use of traditional capacitance probes (or any internal rigid sensor) for measuring liquid in the bladder, since the probes would prevent the bladder from fully collapsing. This is illustrated in FIG. 1, wherein the dashed lines represent a flexible bladder 120 that is prevented from fully collapsing to the level of the fuel 112 by the rigid capacitance-type fuel probes 108(1) to 108(3).

### SUMMARY OF THE DISCLOSURE

In one implementation, the present disclosure is directed to a liquid-gauging system for providing an estimate of an amount of liquid present in a collapsible bladder. The liquid-gauging system includes one or more liquid-gauging sensors configured to be operatively deployed relative to the collapsible bladder and to output one or more corresponding signals relating to an amount of liquid present in the collapsible bladder; circuitry for processing the one or more signals output from the one or more liquid-gauging sensors so as to generate corresponding one or more digital output signals; and machine memory storing: machine-readable information that correlates values of the one or more digital output signals to amounts of liquid present in the collapsible bladder; and machine-executable instruction for using the one or more digital output signals and the machine-readable information to determine the estimate.

In another implementation, the present disclosure is directed to a liquid storage and measurement system comprising a collapsible bladder for containing a liquid and the liquid-gauging system of the foregoing implementation.

In yet another implementation, the present disclosure is directed to an aircraft comprising a fuel system that includes the liquid storage and measurement system of the foregoing implementation.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic diagram illustrating conventional capacitance-type fuel probes in the context of each of a rigid fuel tank and a flexible (collapsible) fuel-storage bladder;

FIG. 2A is a horizontal cross-sectional view of an example collapsible bladder and example pressure-sensor arrangements for a liquid-gauging system of the present disclosure, showing the collapsible bladder filled with a liquid;

FIG. 2B is a horizontal cross-sectional view of the collapsible bladder of FIG. 2A, showing the collapsible bladder partially filled with the liquid;

FIG. 2C is a plan view of the collapsible bladder of FIGS. 2A and 2B;

FIG. 2D is a cross-sectional view of the collapsible bladder of FIGS. 2A-2C, illustrating the collapsible bladder and liquid therein under the influence of an acceleration and/or a non-zero attitude angle;

FIG. 3A is a plan view of an example sensor assembly comprising a plurality of sensors and a connecting structure connecting the pressure sensors to one another to form the pressure sensor arrangement;

FIG. 3B is a cross-sectional view of an example bladder wall containing sensors in three differing locations within the thickness of the wall;

FIG. 4 is a horizontal cross-sectional view of the collapsible bladder of FIGS. 2A-2D, wherein the liquid-gauging system includes a pair of rigid plates located between the collapsible bladder and the support structure;

FIG. 5 is an elevational view of an example liquid-gauging system that includes a collapsible bladder having a variable capacitor deployed as a liquid-gauging sensor, showing the collapsible bladder in a full state and a partially full state;

FIG. 6 is an elevational view of an example liquid-gauging system that includes a collapsible bladder and two variable capacitors deployed as two liquid-gauging sensors, showing the collapsible bladder in a full state and a partially full state;

FIG. 7 is a plan view of an example collapsible bladder showing example arrangements of capacitive plates of variable-capacitor-type liquid-gauging sensors;

FIG. 8 is a cross-sectional view of an example capacitive component that can be used in a variable-capacitor-type liquid-gauging sensor of the present disclosure;

FIG. 9 is a high-level schematic block of an example liquid-gauging system of the present disclosure;

FIG. 10 is a high-level schematic diagram of an example embodiment of a liquid-gauging system of the present disclosure, such as the example liquid-gauging system of FIG. 9;

FIG. 11 is a block diagram of an example embodiment of the signal-conditioner circuit (SCU) of the liquid-gauging system of FIG. 10; and

FIG. 12 is a schematic diagram of an example aircraft having a liquid-gauging system of the present disclosure that includes collapsible-bladder-type wing-mounted fuel tanks.

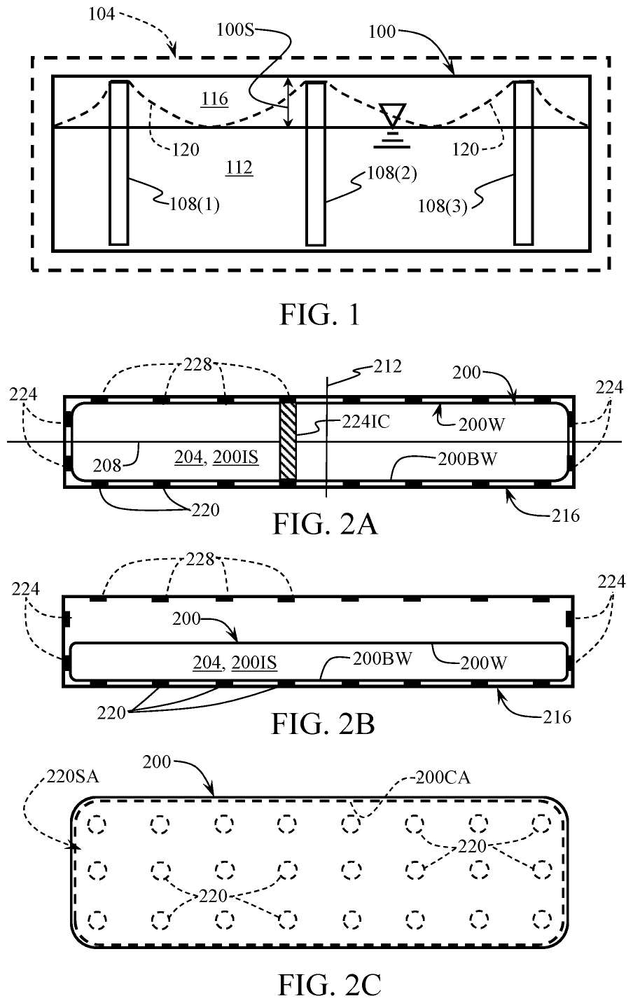

### DETAILED DESCRIPTION

General

Measuring liquid in a collapsible bladder by external means can be preferred. However, when full, a collapsible bladder typically conforms to the shape of the structure supporting it, such as, for example, an aircraft wing. Therefore, external measurement of a collapsible bladder would typically require the liquid-gauging sensors utilized to be extremely thin to fit between the collapsible bladder and the support structure, while allowing the collapsible bladder to reach maximum volume. In some aspects, this disclosure applies to a liquid-gauging system wherein liquid quantity within a collapsible bladder is determined as a function of measuring the capacitance, resistance, or voltage of one or more liquid-gauging sensors, or one more components thereof, located externally to, internally to, or integrally with one or more walls of a collapsible bladder and relating the measurements to a liquid amount (e.g., mass or volume) based on characterization of the relationship between the measurements and the liquid amount. Examples of liquid-gauging sensors include (1) variable capacitors having at least one capacitor plate that moves with a wall of a collapsible bladder as the amount of liquid in the bladder changes, and (2) pressure sensors that measure forces induced by the liquid contained in the collapsible bladder. Each of these types are illustrated in the accompanying drawings and described below.

In some embodiments, the present disclosure is directed to liquid-gauging systems for providing an estimated amount of liquid present in one or more collapsible bladders. Such a liquid-gauging system may include one or more liquid-gauging sensors configured to be operatively deployed relative to the collapsible bladder and located so as to provide one or more corresponding signals relating to the amount of the liquid present in the collapsible bladder. A liquid-gauging system of the present disclosure may also include circuitry for receiving and/or processing the one or more signals output by the one or more liquid-gauging sensors so as to generate one or more digital output signals. In some embodiments, the liquid-gauging system may further include machine memory that stores machine-readable stored information that relates the one or more digital outputs signals to an amount of liquid present in the collapsible bladder and machine-executable instruction for using the one or more digital output signals and the machine-readable information to determine the estimated amount. A liquid-gauging system of the present disclosure can be used for any suitable type of liquid-storage system having a collapsible bladder, such as, for example, a liquid-fuel storage system aboard an aircraft, such as an Unmanned Aircraft System (UAS), among other types of aircraft and other types of liquid-storage systems.

In some embodiments, the present disclosure is directed to a liquid-storage and measurement system that include a liquid-gauging system, such as a liquid-gauging system as described above, in combination with one or more collapsible bladders. In some embodiments, the present disclosure is directed to a liquid-storage system that includes a collapsible bladder with one or more liquid-gauging sensors, or one or more components thereof, engaged with the collapsible bladder. In embodiments in which pressure sensors are utilized as liquid-gauging sensors, a pressure plate may be deployed with each of some or all of the pressure sensors.

In some embodiments, the present disclosure is directed to a vehicle that includes one or more collapsible bladders deployed as part of a fuel system for operating the vehicle. In some examples, the vehicle may be an aircraft (e.g., a UAS), a land-based vehicle, or a water-based vehicle, or any combination thereof. In some examples, the vehicle may be autonomous, manually controlled, or a combination of autonomous and manually controlled, either locally, remotely, or a combination of locally and remotely. Fundamentally, there is no limit on the type of vehicle or the manner by which the vehicle is controlled.

In some embodiments, the present disclosure is directed to a method of estimating an amount of liquid present in one or more collapsible bladders. In such an embodiment, the method may include receiving a sensor output signal from each of one or more liquid-gauging sensors located in operative relation with a collapsible bladder. Based on the one or more output signals, an estimate of the amount of liquid present in the collapsible bladder is determined. The estimate may be output to an output device and/or an external device for use by such device(s) and/or a human user. In some embodiments, the present disclosure is directed to a machine-readable storage medium containing machine-executable instructions for performing a method of estimating an amount of liquid present in a collapsible bladder, such as the method just mentioned, and/or containing measurement-to-liquid-amount correlation information and/or one or more algorithms for determining an estimate of the amount of the liquid present in the collapsible bladder(s).

The foregoing, and other embodiments, are described below and illustrated in the accompanying drawings.

Pressure Sensors as Liquid-Gauging Sensors

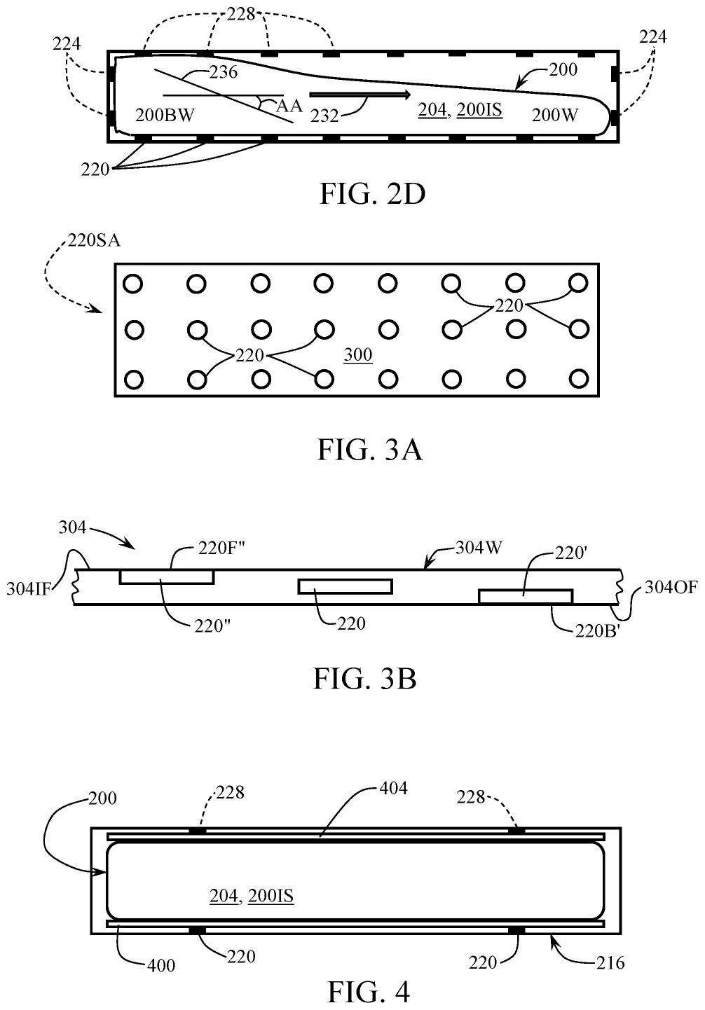

Referring to the drawings, FIGS. 2A-2D show an example collapsible bladder 200 for holding a liquid 204, which can be any type of liquid to be stored or otherwise held in the collapsible bladder. Fundamentally, there is no limit on the type of the liquid 204 other than it be chemically compatible with the bladder 200 (e.g., be chemically inert to the bladder and/or not cause the bladder to prematurely deteriorate) and that it be of a type for which it is desired to know the amount of within the bladder. Detailed examples below are directed to the liquid 204 being a primary fuel, such as an aviation fuel, among others, for the vehicle—specifically an aircraft in the detailed example—for which it is desirable to know the amount of fuel present and/or remaining to ensure that the vehicle can complete its intended mission(s) for the amount of fuel charged to the bladder 200. While the liquid 204 in the detailed examples is a primary liquid fuel, it can be a secondary fuel or, more generally, any other type of liquid as noted above depending on the application at issue.

A characteristic of collapsible bladders, such as the collapsible bladder 200 of FIGS. 2A-2D, is that its wall 200W, which defines an interior space 200IS that contains the liquid 204, is flexible, and this flexibility is desirable for any one or more of a number of reasons. For example, the flexibility of the wall 200W of the collapsible bladder 200 can be desirable because it allows the collapsible bladder, when empty, to be folded and/or rolled for ease of shipping, storing, and/or handling; it allows the collapsible bladder, or one or more portions thereof, to conform to the shape of a space within which it is deployed; and/or it allows the collapsible bladder to deform as liquid is removed from the interior space 200IS, and any logical combination thereof. Regarding deforming as liquid is removed, this can be beneficial to keep air out of the collapsible bladder 200 and/or to prevent changes in pressure within a headspace within the collapsible bladder, as would occur in a rigid closed storage tank. As those skilled in the art know, these are highly beneficial traits for a fuel-storage system aboard a vehicle, such as an aircraft.

In this connection, FIGS. 2A-2D illustrate an example in which the collapsible bladder 200 is relatively expansive in a horizontal plane 208 (see plan view, FIG. 2C) while relatively compact in a vertical plane 212 (see cross-sectional views, FIGS. 2A, 2B, and 2D). However, it is noted that in other embodiments, the situation can be reversed wherein the collapsible bladder is compact in the horizontal plane 208 (FIG. 2A) and expansive in the vertical plane 212 or such that it is equally expansive in both planes. It is also noted that while the collapsible bladder 200 of FIGS. 2A-2D is largely rectilinear in its three-dimensional (3D) shape, a suitable collapsible bladder can be of any 3D, such as a disk shape or even spherical, among a nearly infinite variety of other 3D shapes. All that said, the example generally rectilinear collapsible bladder 200 of FIG. 2A-2D is used to illustrate some general aspects of any collapsible bladder that can be used in connection with the present disclosure.

In some embodiments, a collapsible bladder, such as the collapsible bladder 200 of FIGS. 2A-2D may be considered to have a “baseline” or “fixed” orientation depending on its application. For example, a collapsible bladder for a vehicle may be a baseline orientation in which the collapsible bladder has a bottom side that is on the vertically lower side of the collapsible bladder. In the context of the collapsible bladder 200 of FIGS. 2A-2D, this baseline orientation has a bottom wall 200BW that is horizontal. During use of the vehicle, however, the orientation of the bottom wall 200BW and collapsible bladder 200 generally may change. Effects of changes in orientation are discussed below. In some applications the relevant collapsible bladder(s) may be permanently stationary such that the orientation of the collapsible bladder remains fixed. In the context of the collapsible bladder 200 of FIGS. 2A-2C, in a stationary application the bottom wall 200BW may be considered to have a fixed horizontal orientation.

In the plan view (FIG. 2C), the collapsible bladder 200 may be considered to have a contact area 200CA, which is the area of the bottom wall 200BW (FIG. 2A) that is in contact with a support structure, such as support structure 216 (FIGS. 2A and 2B) that vertically supports the collapsible bladder when the collapsible bladder is in its baseline or fixed orientation. The support structure 216 can be any suitable type of support structure, such as frame of a vehicle, a bladder support within a vehicle or another structure (e.g., building) or outdoors, or a foundation of a fixed installation, among other things.

FIGS. 2A-2D show a plurality of pressure sensors 220 (only a few labeled to avoid clutter) deployed in a sensor arrangement 220SA (FIG. 2C) within the contact area 200CA between the interior space 200IS of the collapsible bladder 200 and the support structure 216. It is noted that each of one or more of the pressure sensors 220 may be replaced by two or more pressure sensors or a cluster or array of pressure sensors, as desired. Generally, each pressure sensor 220 measures an amount (e.g., by weight/force) of the liquid 204 present in a corresponding imaginary column 224IC (FIG. 2A) of the liquid vertically above that pressure sensor. As discussed below, the profile of such amounts across the sensor arrangement 200SA (FIG. 2C) is used to determine a total amount of the liquid 204 in the collapsible bladder 200 when the measurements are made.

The number of the pressure sensors 220 and their arrangement 220SA can vary depending on a variety of parameters, such as the magnitude of the contact area 200CA, the shape of the collapsible bladder 200 (including the shape of the contact area), and the desired spacing between adjacent ones of the pressure sensors, and the desired pattern of the arrangement, among other things. Example sensor arrangements are discussed below. The pressure sensors 220 can be located at any suitable location. In some embodiments, such as illustrated in FIG. 4, the pressure sensors 220 may be strategically placed, shaped, and/or used with one or more rigid bodies to measure the force applied by the weight of the overall bladder, including the liquid contained within it.

The type of pressure sensor used can include, but not be limited to, a thin force-resistive sensor (FRS). FRSs utilize piezoresistive technology, which arranges four resistors in a Wheatstone bridge electrical circuit as a means to measure strain or physical pressure applied. The change in resistance is proportional to the applied pressure and is output as capacitance, resistance, or voltage. FRSs can be utilized as single-point force sensors or in an array, or cluster, to measure applied pressure over a given area. In some embodiments, the pressure sensors 220 can be commercial off-the-shelf (COTS) pressure sensors, while in other embodiments the pressure sensors can be, for example, custom made to suit the particular application at issue. As a single-point-type COTS example, each pressure sensor 220 may be a standard model A201 FLEXIFORCE™ sensor available from Tekscan, Inc., Norwood, Mass. As a array-type COTS example, each pressure sensor 220 may be a standard model A502 FLEXIFORCE™ sensor, also available from Tekscan, Inc.

In some embodiments, the pressure sensors 220 may be deployed between the wall 200W of the collapsible bladder 200 and the support structure 216. For example, each sensor 220 may be affixed to one, the other, or both of the wall 200W and the support structure 216. In some embodiments, the pressure sensors deployed between the wall 200W of the collapsible bladder 200 and the support structure 216 may be connected to one another via a connecting structure 300 (see FIG. 3A), which may, for example, aid in deployment of the arrangement 220SA (FIG. 2C). Examples of structures suitable for the connecting structure 300 (FIG. 3A) include, but are not limited to, a sheet of material, a grid, or a web, among others.

In some embodiments, the pressure sensors 220 may be deployed within one or more walls of a collapsible bladder, such as shown in FIG. 3B. As seen in FIG. 3B, one of the pressure sensors 220 is shown embedded within a wall 304W of a collapsible bladder 304, with portions of the wall entirely surrounding the pressure sensor. FIG. 3B also shows two alternative ways that a sensor can be integrated into a wall 304W of a collapsible bladder 304. Here, the pressure sensor 220′ is integrated into the wall 304W so that its back side 220B′ is exposed on the outside face 3040F of the wall, and the pressure sensor 220″ is integrated into the wall so that its front side 220F″ is exposed on the inside face 304IF of the wall. Other schemes for integrating sensors into bladder walls are possible.

As noted above, a rigid structure may be interposed between a collapsible bladder and a support structure as part of the liquid-measurement system. An example is shown in FIG. 4. As seen in FIG. 4, a first rigid plate 400 is located between the flexible bladder 200 and the support structure 216, with the pressure sensors 220—here, a reduced number of pressure sensors—located between the rigid plate and the support structure. With this configuration, each sensor 220 does not measure the amount of water in a column above it, but rather it measures a corresponding fraction of the sum of all of the forces that go through the pressure sensors collectively.

In some embodiments, the first rigid plate 400 may be eliminated and each pressure sensor 220 (or cluster/array) be provided with a corresponding local pressure plate (not shown) to increase the amount of the liquid 204 influencing that sensor (or cluster). Each such local pressure plate may be any suitable shape in a plane parallel to the adjacent wall 200W of the collapsible bladder 200, such as circular or rectangular, among others. The spacing of such local pressure plates from one another may be such that they nearly abut one another at one extreme to providing significant spacings at an opposite extreme. As noted above, the use of a rigid body, such as the first rigid plate 400 of FIG. 4, or local pressure plates as noted above, can reduce the number of sensors 220 needed. However, a tradeoff is the additional weight that providing a rigid body adds, which can be an important consideration in some applications, such as in an aircraft.

In many embodiments, a collapsible bladder of the present disclosure, such as the collapsible bladders 200 and 304 FIGS. 2A-2C and 3B, may have walls, such as walls 200W and 304W, respectively, made of one or more polymers and, optionally, one or more reinforcing layers (e.g., carbon fiber, glass fiber, etc.), provided in such form(s) and thickness(es) that each wall can be folded back upon itself with the radius of the fold no more than 10 times the thickness of the wall without permanently deforming the wall. In some embodiments, the wall, or a portion thereof, may have an elastic regime (no permanent deformation) and inelastic regime (permanent deformation), with the wall or portion being deployed and used only in its elastic regime. In one example, a wall, or a bottom portion thereof, may be a piece of sheet metal that acts only in its elastic regime under a load of the weight of liquid above it inside the interior space of the collapsible bladder.

It is noted that the term “collapsible bladder” does not necessarily require that the entirety of the structure needs to be flexible/pliable to the extent that the collapsible bladder can be rolled and/or folded back on itself. For example, a collapsible bladder of the present disclosure may have an upper wall that is rigid. It is also noted that there is fundamentally no limit on the amount of liquid (e.g., volume) that a collapsible bladder of the present disclosure may hold, other than strength limitations on the materials used to make the bladder.

As noted above, a collapsible bladder of the present disclosure, such as collapsible bladder 200 of FIGS. 2A-2C, can be used in applications wherein the collapsible bladder is subjected to acceleration(s) other than gravity and/or change(s) in attitude during use, such as use in an aircraft. When the collapsible bladder 200 is in fixed orientation, the pressure sensors 220 can be used to directly measure the weight of the liquid 204. However, when the collapsible bladder 200 is exposed to various accelerations and/or experience differing orientations during use (e.g., during flight and flying maneuvers), the outputs of the pressure sensors 220 can be interpreted with the aid of other data, such as acceleration data and/or attitude data, to provide an accurate estimate of the amount of the liquid 204 in the collapsible bladder. In such applications, additional pressure sensors can be provided to account for such acceleration(s) and change(s) in attitude. FIGS. 2A, 2B, and 2D illustrate examples of such additional sensors, shown as pressure sensors 224 and pressure sensors 228 (only a few of which are labeled to avoid clutter).

FIG. 2D shows collapsible bladder 200 and liquid 204 under the influence of a lateral acceleration (indicated by arrow 232) and/or a non-zero attitude angle, indicated by attitude angle AA relative to horizontal (indicated by horizontal line 236, which is tilted in the case for illustrative purposes). As can be readily seen in FIG. 2D, the pliability of the wall 200W of the collapsible bladder 200 allows the collapsible bladder to change shape relative to its resting shape (FIGS. 2A and 2B) under the influence of the acceleration 232 and/or the non-zero attitude angle AA. To account for this change in shape and shifting of the liquid 204, some or all of the additional pressure sensors 224 and 228 can be used for measuring pressures at corresponding locations.

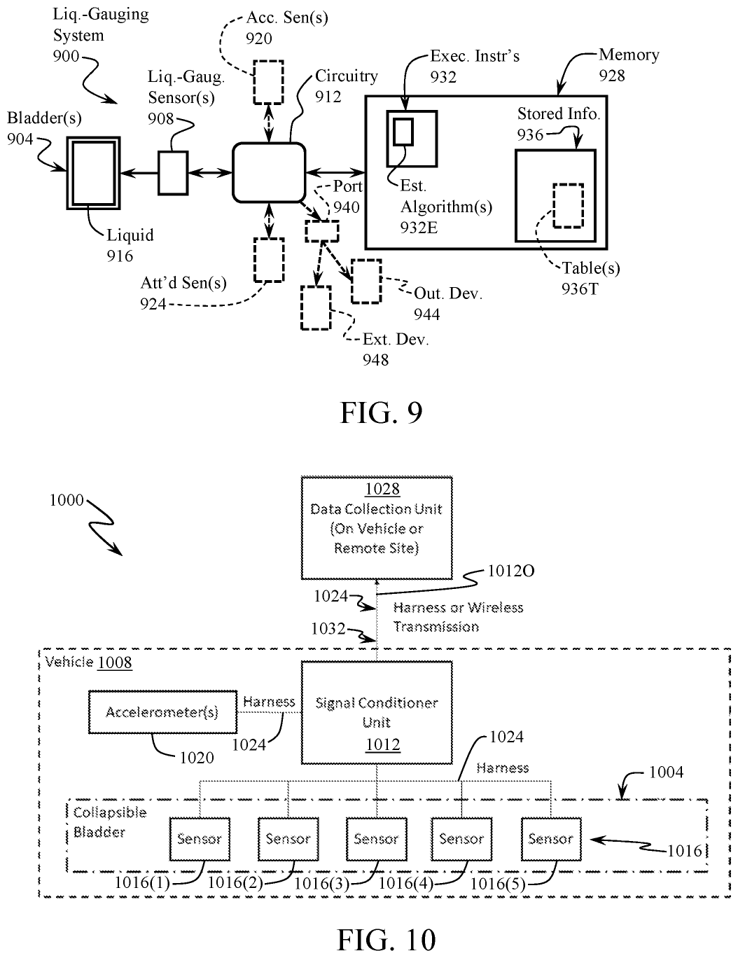

Measurements from the pressure sensors 220 and the ones of the additional pressure sensors 224, 228 deployed or otherwise resulting from signals from these sensors can be used with corresponding acceleration data and/or attitude data to estimate the amount of the liquid 204 in the collapsible bladder 200 under such condition(s). As discussed below, stored information (not shown, but see stored information 936 of FIG. 9), such as one or more lookup tables, can be used to estimate the amount of the liquid 204 present for any given set of measurements based on the pressure sensors 220, 224, 228, one or more accelerometers (not show), and/or one or more attitude sensors (not shown), as the case may be. Depending on the magnitude of the acceleration 232 and/or the magnitude of the attitude angle AA, some or all of the additional pressure sensors 228 shown at the top of the collapsible bladder 200 may not be needed. For example, and for a particular application, if the collapsible bladder 200 will never deform such that ones of the additional pressure sensors 228 would never be engaged, then those pressure sensors can be eliminated from the design for that application. Referring back to FIG. 4, a second rigid structure, here, second rigid plate 404, is provided to work with the additional pressure sensors 228. The additional pressure sensors 224, 228, if provided, can be deployed in the same or similar manner to the example deployments of pressure sensors 220 described above.

Variable Capacitors as Liquid-Gauging Sensors

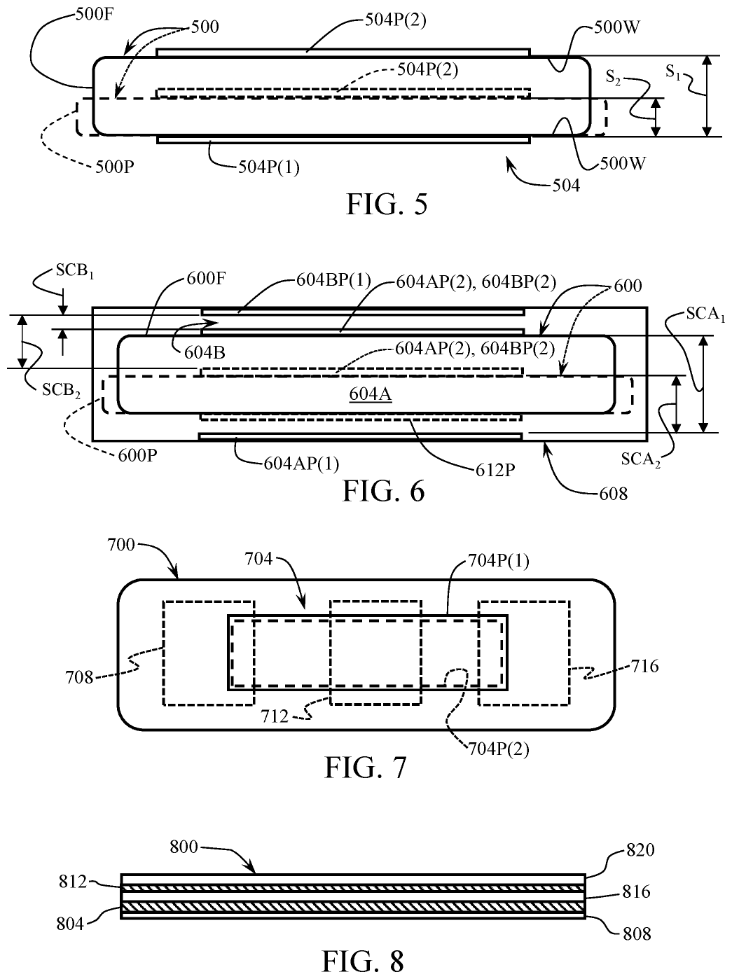

In some embodiments of a liquid-gauging system of the present disclosure, one or more variable-capacitor-type liquid-gauging sensors may replace or supplement the pressure-sensor-type liquid-gauging sensors discussed above. FIG. 5 illustrates a collapsible bladder 500 engaged by a variable capacitor 504 that includes a pair of capacitor plates 504P(1) and 504P(2) secured to the collapsible bladder. The capacitor plates 504P(1) and 504P(2) are located so that, when the collapsible bladder 500 is in differing states of fullness relative to a liquid (not shown) contained within the collapsible bladder, they are spaced apart from one another by differing spacings, here spacings S₁ and S₂. The example illustrated shows the collapsible bladder being full at 500F and partially full at 500P, wherein the capacitor plates 504P(1) and 504P(2) are spaced apart, respectively, by spacings S₁ and S₂.

As those skilled in the art will readily appreciate, when the capacitor plates 504P(1) and 504P(2) are spaced apart at a larger spacing, such as spacing S1 relative to spacing S₂, the capacitance is decreased from the capacitance at the smaller spacing, here, spacing S₂ relative to spacing S₁. This results in the variable capacitor 504 having differing capacitances at differing spacings, such as spacings S₁ and S₂. Consequently, when the capacitive plates 504P(1) and 504P(2) are located so that the spacing between them varies as the amount of liquid within the collapsible bladder 500 changes, measurements reflecting the differing capacitances of the variable capacitor 504 can be correlated to the differing amounts of liquid.

It is noted that the term “capacitor plate” as used herein and in the appended claims does not require any particular rigidity as one might associate with the term “plate”. Consequently, a capacitor plate of the present disclosure can be as thin and/or as otherwise flexible as desired or thick and/or as otherwise rigid as desired. In some embodiments, capacitor plates of the present disclosure, such as capacitor plates 504P(1) and 504P(2) of FIG. 5, are flexible enough that they do not significantly impede the flexibility of the portions of the wall 500W of the collapsible bladder 500 with which they are engaged. In some embodiments, each of the capacitor plates 504P(1) and 504P(2) is secured to an exterior surface of the wall 500W using any suitable means, such as an adhesive (full layer or partial, such as striped or spotted) or weld(s) (full or partial, such as striped or spotted), among others. In some embodiments, the capacitor plates 504P(1) and 504P(2) may be integrated into the wall 500W, such as by locating them within the thickness of the wall.

It is recognized that while FIG. 5 illustrates the capacitor plates 504P(1) and 504P(2) as being parallel to one another, the configuration of the collapsible bladder 500 and/or conditions of the collapsible bladder during use (e.g., change in attitude, influence of non-gravitational acceleration(s), etc.) can cause the capacitor plates to be non-parallel to one another. Suitable measures for accounting for this non-parallelness can be implemented, such as by calibrating the sensor readings of the variable capacitor 504 for differing liquid fullnesses at differing attitude and/or acceleration conditions and/or by augmenting sensor readings of the variable capacitor with one or more attitude and/or acceleration sensors as discussed below in connection with FIGS. 9 and 10.

In an example, measurements relating to the capacitance of the variable capacitor 504 can be made as follows. In this example, one of the capacitor plates 504P(1) and 504P(2), which may be denoted the low-impedance plate, is energized with an AC signal from an AC source (not shown), while the other of the capacitor plates, which may be denoted the high-impedance plate, is electrically connected back to the AC source to form a circuit. The impedance (Z) in this circuit across the variable capacitor 504 is then measured, and the resulting impedance value(s) are used in the process for estimating the amount of liquid in the collapsible bladder 500, as discussed below in connection with FIGS. 9 and 10. In this example, either of the capacitor plates 504P(1) and 504P(2) can be the high-impedance plate.

FIG. 6 illustrates a collapsible bladder 600 and a liquid-gauging system having first and second variable capacitors 604A and 604B, both of which are used to estimate the amount of liquid (not illustrated) contained within the collapsible bladder when measurements relating to the capacitances of the variable capacitors are made. In this example, the collapsible bladder 600 is surrounded by a structure 608, such as a bladder shell or structure of a vehicle, among others, that is fixed relatively to all parts of the collapsible bladder. Also in this example, the first variable capacitor 604A is formed by capacitor plates 604AP(1) and 604AP(2) engaged with a lower portion of the structure 608 and an upper portion of the flexible wall of the collapsible bladder 600, respectively. As can be readily seen from the differing capacitor spacing SCA₁ and SCA₂, when the collapsible bladder 600 is full (600F) and partially full (600P), the change in capacitance of the first variable capacitor 604A can be correlated to change in the amount of the liquid contained within the collapsible bladder, such that measurements relating to the capacitance of the first variable capacitor can be used to estimate such amount as noted above relative to the variable capacitor 504 of FIG. 5.

In this example of FIG. 6, the second variable capacitor 604B is formed by capacitor plates 604BP(1) and 604BP(2), which are engaged, respectively, with the structure 608 and the collapsible bladder 600. As can be readily seen from the differing capacitor spacing SCB₁ and SCB₂, when the collapsible bladder 600 is full (600F) and partially full (600P), the change in capacitance of the second variable capacitor 604B can be correlated to change in the amount of the liquid contained within the collapsible bladder, such that measurements relating to the capacitance of the first variable capacitor can be used to estimate such amount as noted above in connection with the variable capacitor 504 of FIG. 5. Measurements from both the first and second variable capacitors 604A and 604B of FIG. 6 can be used together, for example, to increase the accuracy of the estimates and/or to provide redundancy.

In this example, the capacitor plate 604BP(2) of the second variable capacitor 604B is also the capacitor plate 604AP(2) of the first variable capacitor 604A. If the excitation and measurement scheme discussed above relative to the variable capacitor 504 of FIG. 5 is used, then this combined capacitor plate 604AP(2)/604BP(2) can be the low-impedance plate that is driven by the AC source.

In some embodiments, an additional capacitor plate 612P may be engaged with the collapsible bladder 600, such as with the bottom of the collapsible bladder as shown. While not shown, the capacitor plate 612P can be used to form one or more other variable capacitors, such as with any one or more of the three other capacitor plates 604AP(1), 604AP(2)/604BP(2), and 604BP(1). For example, a variable capacitor formed by capacitor plates 612P and 604AP(1) can be used in the entire assembly as shown in FIG. 6 is inverted, such as in an aircraft flying in an inverted-roll orientation, among other possibilities. Those skilled in the art will readily appreciate that excitation signals may need to be sequenced among two or more of the variable capacitors to ensure that there is no crosstalk between/among the variable capacitors being used for measurements.

FIG. 7 illustrates a collapsible bladder 700 that can be the same as or similar to each of the collapsible bladders 500 and 600 of FIGS. 5 and 6. FIG. 7 also shows a few examples of variable capacitors 704, 708, 712, and 716 in working relation to the collapsible bladder 700. The variable capacitor 704 comprises a first capacitor plate 704P(1) located above, on, or within the wall of the collapsible bladder 700 closest to the viewer of FIG. 7, and a second capacitor plate 704P(2) located below, on, or within the wall of the collapsible bladder farthest from the view of FIG. 7. The variable capacitor 704 may be, for example, the same as or similar to any of the variable capacitors 504, 604A, and 604B of FIGS. 5 and 6 in terms of size, location, and/or other attributes.

The areal size (in the x-y plane, with the z-plane being into and out of the page containing FIG. 7) of each capacitor plate 704P(1) and 704P(2) may be the same as the other, or the areal sizes may differ from one another. Typically, the capacitor plates 704P(1) and 704P(2) will be in registration with one another, though it is recognized that deformation of the collapsible bladder 700 may cause the capacitor plates to move out of perfect registration to one extent or another. The areal sizes of the capacitor plates 704P(1) and 704P(2) relative to the surface areas of the walls to which they relate (here, either the nearest wall or the farthest wall, as discussed above) and the location of the capacitor plates can be selected as desired or needed, depending, for example, on the shape of the collapsible bladder at issue. For example, the areal size of each capacitor plate 704P(1) and 704P(2) could be coextensive with the areal size of the wall with which it is associated or could be smaller than that areal size, such as shown in FIG. 7.

As noted above, FIG. 7 shows an example of other variable capacitors, in this case three variable capacitors 708, 712, and 716, that may be used singly or in various combinations with one another in lieu of the variable capacitor 704. For example, all three of the variable capacitors 708, 712, and 716 may be used together, the variable capacitors 708 and 716 may be used together (i.e., the variable capacitor 712 is not provided), or the variable capacitor 712 may be used alone (i.e., the variable capacitors 708 and 716 not provided). Although not illustrated, each of the variable capacitors 708, 712, and 716 includes a pair of capacitor plates that can be located relative to one another and to the collapsible bladder 700 in the same or similar manner as discussed above relative to the first and second capacitor plates 704P(1) and 704P(2) of the variable capacitor 704. The areal size of each of the variable capacitors 708, 712, and 716 may be any needed to suit a particular design situation. It is noted that the three variable capacitors 708, 712, and 716 are provided simply for illustration, and more or fewer variable capacitors may be used.

FIG. 8 illustrates an example construction of a capacitor element 800 that can be, for example, applied to an exterior surface of a collapsible bladder (not shown) as part of a variable capacitor, such as any of the variable capacitors disclosed herein, including 504, 604A, 604B, 704, 708, 712, and 716 of FIGS. 5-7. In this example, the capacitor element 800 of FIG. 8 includes a capacitor plate (a/k/a, “electrode”) 804 that provides one of the two capacitor plates of the variable capacitor (not shown) that the capacitive element is used to make. The capacitor plate 804 may be made of any suitable conductive material(s), such as a metal film, a metal foil, or a metal sheet, among others. Typically, the entirety of the capacitor element 800 is designed to be flexible to conform to the shape of the bladder wall to which it will be affixed.

In this example, the capacitor element 800 includes an attachment layer 808 designed and configured for securing the capacitor element to a collapsible bladder. The attachment layer 808 may comprise, for example, an adhesive or a weldable material, among other materials that can be used to secure the capacitor element 800 to the collapsible bladder. In some embodiments the attachment layer 808 is continuous, while in other embodiments the attachment layer is discontinuous.

The example capacitor element 800 may include an optional shielding layer 812 to electromagnetically shield the capacitor plate 804 from any nearby structures (not shown) that could interfere with the functioning of the variable capacitor in which the capacitor element is used. The shielding layer 812 may be made of any suitable electrically conductive material(s) as known in the art. When the shielding layer 812 is provided, an electrically insulating layer 816 may be provided between the capacitor plate 804 and the shielding layer. As known in the art, the insulating layer 816 may be made of any suitable dielectric material(s).

In some embodiments, the capacitor element 800 may include an encapsulating layer 820, which may be provided to protect the shielding layer 812 and/or other components of the capacitor element. If provided, the encapsulating layer 820 may be made of one or more suitable dielectric materials that are robust enough to withstand any external conditions the encapsulating layer is designed to endure during the service life of the capacitor element.

In some embodiments, all of the layers 804 through 820 or a subset thereof may be laminated with one another to provide a monolithic, easily handled structure. In some embodiments, the lamination may be effected by providing each of the attachment layer 808, the insulating layer 816, and the encapsulating layer 820 with a heat-weldable material such that the capacitor element 800 may be formed using a heat press (not shown). In some embodiments, the various ones of the layers 804 through 820 may be laminated together using adhesive lamination and a cold press, among other things. Those skilled in the art will readily appreciate that there are a variety of ways that the various layers 804 through 820 may be secured to one another.

As noted above, a capacitor plate may be integrated into a wall of a collapsible bladder. In the context of FIG. 8, this figure can be alternatively viewed as illustrating a cross-section of a bladder wall 800. With such a view, the layers 808, 816, and 820 may be viewed as being non-electrically conductive portions of the bladder wall 800, rather than as being the specific layers noted above. In this connection, it is noted that the shielding layer 812 can be omitted from the bladder wall 800 in some embodiments.

Example Liquid-Gauging Systems

FIG. 9 illustrates an example liquid-gauging system 900. In this example, the liquid-gauging system 900 includes one or more collapsible bladders (only one collapsible bladder 904 shown and described for simplicity), a plurality of liquid-gauging sensors (collectively shown at block 908), and circuitry 912 for processing inputs and other information for estimating the amount of a liquid 916 within the collapsible bladder. The collapsible bladder 904 may be the same as or similar to any of the collapsible bladders shown and/or described herein, such as the collapsible bladder 200 of FIGS. 2A-2D and 4, the collapsible bladder 300 of FIG. 3B, and the collapsible bladders 500, 600, and 700 of FIGS. 5-7, respectively, among others, and any similar or other collapsible bladder known in the art. The plurality of liquid-gauging sensors 908 may be the same as or similar to any of the liquid-gauging sensors shown and/or described herein, such as the pressure sensors 220, 224, and 228 of FIGS. 2A-2D and 4, the pressure sensors 220′ and 220″ of FIG. 3B, and the variable-capacitor-type sensors 504, 604A, 604B, 704, 708, 712, and 716 of FIGS. 5-7, among others, and any similar or other liquid-gauging sensors known in the art.

The circuitry 912 may be any suitable circuitry for estimating the amount of a liquid 916 in the collapsible bladder 904. Examples of components of the circuitry include, but are not limited to, one or more processors (e.g., general purpose microprocessors, application-specific integrated circuits (ASICs), field programmable arrays, etc.), one or more analog-to-digital (A/D) converters, and one or more signal conditioners, among others. In some embodiments, the circuitry 912 may be embodied in a signal conditioner unit (SCU), such as the example SCU 1012 of FIG. 10 described below in more detail. Still referring to FIG. 9 for now, those skilled in the art will readily understand the nature of the circuitry 912 and the variety of forms and compositions the circuitry may take such that exhaustive examples and detailed explanations are not necessary for those skilled in the art to practice the present inventions to their fullest scope without undue experimentation.

In some embodiments, the liquid-gauging system 900 may include one or more acceleration sensors (e.g., accelerometer(s)) (singly/collectively illustrated at 920) and one or more attitude sensors (singly/collectively illustrated at 924), as needed, to measure any acceleration(s) and/or attitude angle(s) needed for the liquid-estimation process at hand. Each acceleration sensor 920 and each attitude sensor 924 may be of any suitable type, such as a COTS type, among others. Those skilled in the art designing a liquid-gauging system of the present disclosure, such as the liquid-gauging system 900, will be familiar with any acceleration sensor(s) and/or attitude sensor(s) needed for the application at hand.

In this example, the liquid-gauging system 900 includes machine memory 928 that contains a variety of software (i.e., machine-executable instructions 932) and stored information 936, both for functionalizing hardware components of the liquid-gauging system and allowing the circuitry 912 to estimate the amount of the liquid 916 in the collapsible bladder 904. The machine-executable instructions 932 include one or more estimating algorithms 932E for generating each estimate. The estimating algorithm(s) 932E use measurements based on the pressure sensors 908 and if, or as, needed measurements based on the acceleration sensor(s) 920 and/or information based on the attitude sensor(s) 924, as well as the stored information 936. Those skilled in the art will readily be able to devise the algorithm(s) 932E depending on the application at hand.

Examples of information that the stored information 936 can comprise includes, but is not limited to, one or more lookup tables, one or more digitized curves, and one or more equations, among other things. The stored information 936 may be determined in any of a variety of ways, including testing an actual instantiation of the relevant collapsible bladder 904 under differing fullness conditions, differing acceleration scenarios, and/or differing attitude conditions and/or running a computer model configured to model the relevant conditions. The machine-memory 928 may be any suitable hardware memory, including, but not limited to, RAM, ROM, electrically erasable programmable read-only memory (EEPROM), cache memory, etc., and any combination thereof. Fundamentally, there are no limitations on the type(s) and number of hardware memories that can be present in the machine-memory 928. It is noted that the term “machine-memory” excludes transitory signals, including signals carried on carrier waves.

The liquid-gauging system 900 may also include an output port 940 that outputs each liquid-amount estimate to an output device 944 that is part of the liquid-gauging system and/or an external device 948 that is not part of the liquid-gauging system. The output port 940 may include any suitable type of output device, such as a wired device (e.g., connector port) or a wireless device (e.g., a radio or optical transmitter or optical transceiver), or any combination thereof. The output device 944 may be any suitable device, such as a display device (e.g., an electromechanical display, video display, etc.) or printer, among other things. If present, the external device 948 may be a local or remote computer or other machine, such as a vehicle computer aboard a vehicle or a remote-control device in communication with a vehicle, among others. Although not illustrated, communications between the circuitry 912 and any output device 944 and/or any external device 948 may involve one or more networks (not shown), such as a local-area network (LAN) (e.g., a controller-area network (CAN), the Internet, and/or a cellular network, among many others).

The relationship between the sensor measurements and the mass (or volume) of the liquid 916 inside the collapsible bladder 904 may be characterized through a mapping process. For example, the collapsible bladder 904 may be set at level attitude and filled with the liquid 916 at predefined increments with a known mass (or volume) that have been precisely measured using a calibrated scale (or volume-graduated container) (neither shown). At each increment, a measurement is taken from each of the liquid-gauging sensors 908 to correlate the output with the known mass (or volume).

Options for correlation when utilizing pressure sensors for the liquid-gauging sensors 908 include: (1) each sensor measurement is correlated to a portion of the total quantity of the liquid 916 based on the position of the corresponding liquid-gauging sensor 908 on the collapsible bladder 904 and then summed together to capture the total, and (2) each sensor measurement is correlated to the total liquid quantity and the sum is divided by the total number of the pressure sensors. If any of the liquid-gauging sensors 908 is on a portion of the collapsible bladder 904 where no pressure is applied, the contribution of that pressure sensor is zero for that liquid quantity. The fill increments are repeated until the collapsible bladder 904 is full. The same process can be repeated while draining the liquid 916 from the collapsible bladder 904 at predefined increments. The results of the mapping process can be used to generate one or more sensor-output-to-liquid-mass (or volume) tables, curve(s), and/or equation(s), such as one or more sensor-output-to-liquid-amount tables 936T of the stored information 936 stored in the machine memory 928.

Once characterized, a similar process can be used to determine the accuracy of the liquid-gauging system 900. For example, at each fill and/or drain increment, the difference between the mass (volume) of the liquid 916 measured by the liquid-gauging sensors 908 (based on characterization) and the actual mass (volume) of the liquid in the collapsible bladder 904 (based on scale measurements) represents a system error at the given increment.

In certain applications wherein pressure sensors are used for the liquid-gauging sensors 908, such as vehicle-based applications (e.g., aircraft), as the collapsible bladder 904 empties and collapses, pressures at certain portions of it may become difficult to measure, since little to no pressure will be applied at attitudes of the collapsible bladder that deviate from the level attitude used during the mapping process. Therefore, in some embodiments additional sensors, such as the acceleration sensor(s) 920 and/or attitude sensor(s) 924 may be used in conjunction with the pressure sensors 908 to increase accuracy of the liquid-gauging system depending on the application at issue.

For example, for applications involving moving vehicles (e.g., aircraft), measurements from one or more vehicle-borne accelerometers 920, which can be preexisting or added specifically in conjunction with the liquid-gauging system 900, can be used to account for error in measurements of the liquid 916 due to attitude of the collapsible bladder 904 and/or maneuvering. Regarding calibration, the mapping process for the pressure sensors discussed above can be repeated at various attitudes and/or maneuvering conditions to characterize the relationship between the measurements and liquid quantify at a given attitude and/or maneuvering condition. As noted above, the results of the mapping process can be used to generate several sensor-output-to-liquid-mass tables (collectively represented at 936T), for example, one sensor-output-to-liquid-mass table for each defined attitude. In this scenario, the circuitry 912 could receive a vehicle attitude from the accelerometer(s) 920 and then chooses the corresponding sensor-output-to-liquid-mass table 936T to convert the sensor measurements to a liquid mass (volume). Those skilled in the art would readily understand, if volume is used, that an adjustment for temperature may be needed.

Instantiated Liquid-Gauging System for an Aircraft

FIG. 10 illustrates an example liquid-gauging system 1000 that was developed for the fuel tank (collapsible bladder 1004) of a particular UAS (vehicle 1008), but the general principles underlying this example liquid-gauging system are pertinent to many other types of applications including, but not limited to, automotive, marine, and space vehicles or any vehicle or non-vehicle application. In some applications, the liquid-gauging system 1000 provides real-time remaining-fuel mass measurements to an operator (not shown) of the vehicle 1008, which allows the operator to extend mission times relative to conventional missions for which only pre-mission measurements are made, and to return the vehicle to base prior to running out of fuel. One skilled in the art will recognize the benefit(s) of knowing (e.g., by a human and/or an automated system) the amount of liquid present or remaining in a collapsible bladder, such as the fuel (not shown) remaining in the collapsible bladder 1004 of FIG. 10, given the particular scenario into which the liquid-gauging system 1000 is deployed.

Referring to FIG. 10, the circuitry 912 of FIG. 9 is embodied in the liquid-gauging system of FIG. 10 as an SCU 1012, which, in some instantiations, can be generally similar to SCUs used for capacitance-type liquid-measuring probes currently used in the aviation industry. Also like the liquid-gauging system 900 of FIG. 9, the liquid-gauging system 1000 of FIG. 10 includes one or more liquid-gauging sensors 1016, here pressure sensors 1016(1) to 1016(5), and one or more accelerometers 1020. That said, these pressure sensors 1016(1) to 1016(5) could be replaced or supplemented by one or more variable-capacitor-type sensors. In this example, the SCU 1012, the liquid-gauging sensors 1016, and the accelerometer(s) 1020 are in communication with one another via one or more electrical harnesses 1024, for example, using any suitable communications protocol, such as a CAN protocol, among others. The embodiment shown also includes a data collection unit (DCU) 1028, which may be located onboard or offboard the vehicle 1008, depending, for example, on the type of vehicle (e.g., manned or unmanned). If the DCU 1028 is located onboard the vehicle 1008, then it may be in communication with the SCU 1012 via the electrical harness(es) 1024. If the DCU 1028 is located offboard the vehicle 1008, then it may be in communication with the SCU via a suitable wireless link 1032.

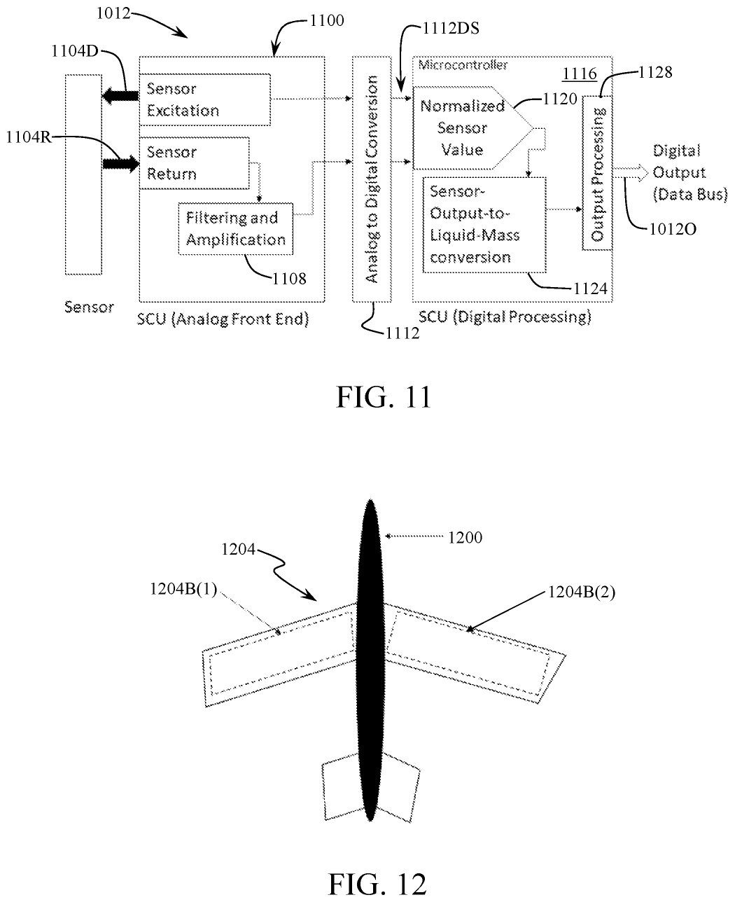

FIG. 11 shows an example embodiment of the SCU 1012 of FIG. 10. In this example, the SCU 1012 includes an analog front end 1100 that sends a drive signal 1104D to each of the liquid-gauging sensors 1016 and reads and processes the return signal 1104R. In one example in the context of a variable capacitor as a liquid-gauging sensor, the drive signal 1104D may be an AC signal provided to a low-impedance capacitor plate, such as discussed above in connection with FIG. 5, and the return signal 1104R may be the signal that is returned from the high-impedance capacitor plate. The analog front end 1100 also includes filtering-and-amplification circuitry 1108 that filters and amplifies the return signal 1104R to provide a conditioned analog signal 1108AS for input to an A/D converter 1112, which converts a conditioned analog signal to a digital signal 1112DS.

In this example, the SCU 1012 also includes a microcontroller 1116 that receives the digital signal 1112DS and executes embedded software (not shown, but see the machine-executable instructions 932 of FIG. 9). At blocks 1120, 1124, and 1128, the embedded software, respectively, normalizes the sensor values carried on the digital signal 1112DS, converts normalized sensor values to corresponding estimates of liquid mass, and processes the estimated values to provide outputs 10120. The microcontroller 1116 can incorporate one or more algorithms (not shown, but see the estimation algorithms 932E of FIG. 9) that convert(s) the sensor signals into liquid mass using sensor-output-to-liquid-mass tables (not shown, but see the sensor-output-to-liquid-mass tables 936T) generated during the mapping process, an example of which is described above. In some embodiments, the sensor-output-to-liquid-mass tables may be saved on EEPROM or any other suitable type(s) of machine memory (see the machine memory 928 of FIG. 9). In this example, the SCU 1012 (FIGS. 10 and 11) outputs an estimated liquid mass via an output 10120, which may be an analog signal (e.g., using a 0V-5V signal scheme) or a digital signal (e.g., using the ARINC (Aeronautical Radio INC) or other digital protocol standard) to the DCU 1028 (FIG. 10) that may be located at any suitable location as discussed above relative to FIG. 10. In this example, the DCU 1028 serves as a central electronic storage unit, which retrieves signals from various systems/components on the vehicle (e.g., aircraft), such as a fuel management system and temperature sensors (not shown) in addition to the liquid-gauging system, for further processing and/or output to a display (such as a fuel gauge) (not shown) to be observed by the operator.

An alternative to the example SCU 1012 (FIG. 10) may include a device (not shown) with less circuitry, in which the device simply sends a drive signal to the sensors and receives the return signal, but then transmits the raw data to the DCU 1028 for further filtering and processing. Another iteration includes saving data to the microprocessor local memory rather than to a separate EEPROM.

FIG. 12 illustrates an example aircraft 1200 having a liquid-gauging system 1204 of the present disclosure that includes a pair of wing-mounted collapsible bladders 1204B(1) and 1204B(2). Other components (not shown) of the liquid-gauging system 1204 not illustrated may be the same as or similar to any of the liquid-gauging systems disclosed herein, including, but not limited to, the liquid-gauging systems 900 and 1000 of FIGS. 9 and 10, respectively.

In some aspects, the present disclosure is directed to a liquid-storage system. The system includes a collapsible bladder having a wall defining an interior space that contains a liquid when the liquid-storage system is deployed for use; and one or more liquid-gauging sensors operatively engaged with the wall so that, when the liquid-storage system is deployed for use, the one or more liquid-gauging sensors located so that, when the liquid is contained in the collapsible bladder, the one or more liquid-gauging sensors provide, respectively, one or more output signals relating to an amount of the liquid contained in the collapsible bladder.

In one or more embodiments of the system, wherein the one or more liquid-gauging sensors includes a capacitor comprising a pair of spaced-apart capacitor plates designed and configured to be located relative to one another and to the collapsible bladder so that, when the collapsible bladder collapses due to withdrawal of the liquid therein, a distance between the pair of spaced-apart capacitor plates changes because of the collapse.

In one or more embodiments of the system, wherein the collapsible bladder has a pair of walls that are spaced from one another when liquid is present in the collapsible bladder, and the pair of spaced-apart capacitor plates are designed and configured to be deployed on corresponding respective walls of the pair of walls.

In one or more embodiments of the system, wherein each wall of the pair of walls has an exterior, and each of the pair of spaced-apart capacitor plates is designed and configured to be secured to the exterior of the corresponding wall.

In one or more embodiments of the system, wherein each wall of the pair of walls has a thickness, and each of the pair of spaced-apart capacitor plates is designed and configured to be contained within the thickness of the corresponding wall.

In one or more embodiments of the system, wherein the collapsible bladder has a first wall, and one of the spaced-apart capacitor plates is engaged with the first wall and another of the space-apart capacitor plates is engaged with a support structure adjacent to the collapsible bladder.

In one or more embodiments of the system, wherein each of the one or more liquid-gauging sensors is a pressure sensor designed and configured to be located relative to the collapsible bladder so as to measure a pressure caused by the liquid within the collapsible bladder when each of the one or more pressure sensors is deployed for use.

In one or more embodiments of the system, comprising a plurality of pressure sensors.

In one or more embodiments of the system, further comprising a plurality of pressure plates corresponding respectively to the plurality of pressure sensors, wherein the plurality of pressure plates are located between the plurality of pressure sensors and the interior space.

In one or more embodiments of the system, wherein the wall has a thickness, and the plurality of pressure plates are integrated within the thickness of the wall of the collapsible bladder.

In one or more embodiments of the system, wherein each of the plurality of pressure plates is circular.

In one or more embodiments of the system, wherein each of the plurality of pressure plates is integrated into the wall of the collapsible bladder.

In one or more embodiments of the system, wherein the collapsible bladder has a footprint area having a lateral perimeter and a central portion located inward of the lateral perimeter, wherein all of the plurality of pressure sensors are located in the central portion away from the lateral perimeter.

In one or more embodiments of the system, wherein the collapsible bladder has an exterior face, and the plurality of pressure sensors are secured to the exterior face of the wall.

In one or more embodiments of the system, further comprising signal-conditioning circuitry in operative communication with the plurality of pressure sensors.

In one or more embodiments of the system, wherein the signal conditioning circuitry is integrated with the collapsible bladder.

In one or more embodiments of the system, further comprising a machine memory containing machine-readable information for correlating the pressure-output signals to amounts of the liquid present in the collapsible bladder.

In one or more embodiments of the system, wherein the machine-readable information comprises at least one sensor-output-to-liquid-amount table containing predetermined data relating values of the digital output signals to corresponding liquid amounts.

In one or more embodiments of the system, wherein the at least one sensor-output-to-liquid-amount table includes a plurality of sensor-output-to-liquid-amount tables for differing attitudes of the collapsible bladder.

In one or more embodiments of the system, wherein the machine memory is integrated with the collapsible bladder.

In some aspects, the present disclosure is directed to a collapsible bladder for containing a liquid. The collapsible bladder includes a flexible wall that allows the collapsible bladder to collapse when the liquid is withdrawn from the collapsible bladder; and at least one component of at least one liquid-gauging sensor integrated with the flexible wall.

In one or more embodiments of the system, wherein the at least one liquid-gauging sensor comprises a capacitor, and the at least one component is a capacitor plate of the capacitor.

In one or more embodiments of the system, wherein the flexible wall has first and second portions spaced apart from one another, the at least one liquid-gauging sensor comprises a capacitor, and the at least one component comprises first and second capacitor plates integrated, respectively, with the first and second portions of the flexible wall.

In one or more embodiments of the system, wherein the at least one liquid-gauging sensor comprises a plurality of pressure sensors.

In one or more embodiments of the system, wherein the flexible wall has first and second portions spaced apart from one another, wherein some of the plurality of pressure sensors are located on the first portion and some of the plurality of sensors are located on the second portion.

In some aspects, the present disclosure is directed to a method of estimating an amount of liquid present in a collapsible bladder. The method includes receiving a sensor output signal from each of one or more liquid-gauging sensors located in operative relation with the collapsible bladder, based on the one or more sensor output signals, determining an estimate of the amount of the liquid present in the collapsible bladder, and outputting the estimate to an output device.

In one or more embodiments of the system, wherein the one or more liquid-gauging sensors comprises a capacitive sensor having at least one capacitor plate engaged with the collapsible bladder.

In one or more embodiments of the system, wherein the one or more liquid-gauging sensors comprises a capacitive sensor having a pair of capacitor places engaged, respectively, with opposing walls of the collapsible bladder.

In one or more embodiments of the system, wherein the one or more liquid-gauging sensors comprises a capacitive sensor having a first capacitor plate engaged with the collapsible bladder and a second capacitor plate engaged with a structure adjacent to the collapsible bladder.

In one or more embodiments of the system, wherein the one or more liquid-gauging sensors comprise one or more pressure sensors.

In one or more embodiments of the system, wherein determining the amount of the liquid includes executing an algorithm that looks up, in at least one sensor-output-to-liquid-amount table, an amount of the liquid in the collapsible bladder as a function of the received one or more output signals.

In one or more embodiments of the system, wherein determining the amount of the liquid includes receiving attitude information regarding an attitude of the collapsible bladder and selecting a sensor-output-to-liquid-amount table as a function of the attitude information.

In one or more embodiments of the system, wherein receiving a sensor output signal from each of one or more liquid-gauging sensors located in operative relation with the collapsible bladder includes receiving a plurality of sensor output signals from a plurality of weight-pressure sensors located in differing locations relative to the collapsible bladder so as to sense corresponding weights of the liquid contained in the collapsible bladder.

In one or more embodiments of the system, wherein receiving a sensor output signal from each of one or more pressure sensors located in operative relation with the collapsible bladder includes receiving a sensor output signal from a liquid-pressure sensor in fluid communication with the liquid in the collapsible bladder so as to sense pressure in the liquid.

In some aspects, the present disclosure is directed to a machine-readable storage medium containing machine-executable instruction for performing the method of estimating an amount of liquid present in a collapsible bladder.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A liquid-gauging system for providing an estimate of an amount of liquid present in a collapsible bladder, the liquid-gauging system comprising:
one or more liquid-gauging sensors configured to be operatively deployed relative to the collapsible bladder and to output one or more corresponding signals relating to an amount of liquid present in the collapsible bladder;
circuitry for processing the one or more signals output from the one or more liquid-gauging sensors so as to generate corresponding one or more digital output signals; and
machine memory storing:
machine-readable information that correlates values of the one or more digital output signals to amounts of liquid present in the collapsible bladder; and
machine-executable instruction for using the one or more digital output signals and the machine-readable information to determine the estimate.

2. The liquid-gauging system of claim 1, wherein:
the machine-readable information includes at least one sensor-output-to-liquid-amount table containing predetermined data relating values of the digital output signals to corresponding liquid amounts; and
the machine-executable instructions include a lookup algorithm designed and configured to look up and/or interpolate liquid amounts in the at least one sensor-output-to-liquid-amount table based on the digital output signals.

3. The liquid-gauging system of claim 2, wherein:
the machine-readable information includes a plurality of sensor-output-to-liquid-amount tables containing predetermined data relating values of the digital output signals to corresponding liquid amounts for a plurality of differing attitudes of the collapsible bladder; and
the machine memory contains machine-executable instructions for:
receiving attitude information regarding attitude of the collapsible bladder; and
determining which of the plurality of sensor-output-to-liquid-amount tables to use based on the attitude information received.

4. The liquid-gauging system of claim 1, wherein the one or more liquid-gauging sensors includes a capacitor comprising a pair of spaced-apart capacitor plates designed and configured to be located relative to one another and to the collapsible bladder so that, when the collapsible bladder collapses due to withdrawal of the liquid therein, a distance between the pair of spaced-apart capacitor plates changes because of the collapse.

5. The liquid-gauging system of claim 4, wherein the collapsible bladder has a pair of walls that are spaced from one another when liquid is present in the collapsible bladder, and the pair of spaced-apart capacitor plates are designed and configured to be deployed on corresponding respective walls of the pair of walls.

6. The liquid-gauging system of claim 5, wherein each wall of the pair of walls has an exterior, and each of the pair of spaced-apart capacitor plates is designed and configured to be secured to the exterior of the corresponding wall.

7. The liquid-gauging system of claim 5, wherein each wall of the pair of walls has a thickness, and each of the pair of spaced-apart capacitor plates is designed and configured to be contained within the thickness of the corresponding wall.

8. The liquid-gauging system of claim 1, wherein the amount is by weight.

9. The liquid-gauging system of claim 1, wherein the amount is by volume, and the machine memory includes machine-executable instructions for calculating an amount by weight based on the volume and a temperature of the liquid.

10. The liquid-gauging system of claim 1, wherein the collapsible bladder is a fuel bladder and the liquid is a fuel.

11. The liquid-gauging system of claim 1, wherein each of the one or more liquid-gauging sensors is a pressure sensor designed and configured to be located relative to the collapsible bladder so as to measure a pressure caused by the liquid within the collapsible bladder when each of the one or more pressure sensors is deployed for use.

12. The liquid-gauging system of claim 11, wherein each of the one or more pressure sensors is associated with a corresponding pressure plate that engages with the collapsible bladder so that, when the liquid-gauging system is deployed, each of the one or more pressure sensors is located between the pressure plate and a support that supports the collapsible bladder.

13. The liquid-gauging system of claim 12, comprising a plurality of pressure sensors and a plurality of corresponding pressure plates.

14. The liquid-gauging system of claim 13, wherein each corresponding pressure plate is circular.

15. The liquid-gauging system of claim 1, further comprising a display system that presents the estimation to a user.

16. The liquid-gauging system of claim 15, further comprising a wireless transmission system for wirelessly transmitting the estimation to the display system.

17. The liquid-gauging system of claim 1, further comprising a wireless transmission system for wirelessly transmitting an external system.

18. The liquid-gauging system of claim 17, wherein the collapsible bladder is a fuel bladder aboard an unmanned aircraft, the liquid is a fuel, and the external system is a remote aircraft control system.

19. A liquid storage and measurement system, comprising:
a collapsible bladder for containing a liquid; and
the liquid-gauging system of claim 1.

20. An aircraft comprising a fuel system that includes the liquid storage and measurement system of claim 19.
